(19) United States
(12) Patent Application Publication
(10) Pub. No.: US 2010/0245220 A1
(43) Pub. Date: Sep. 30, 2010

(54) SYSTEM FOR DISPLAYING IMAGES

(75) Inventors: Shao-Wu HSU, Hsinchu City (TW); Su-Jung HSU, Jhunan Township (TW); Dai-Liang TING, Hsinchu City (TW)

Correspondence Address: LOWE HAUPTMAN HAM & BERNER, LLP, 1700 DIAGONAL ROAD, SUITE 300, ALEXANDRIA, VA, 22314, US

(73) Assignee: TPO DISPLAYS CORP., Miao-Li County (TW)

(21) Appl. No.: 12/725,718

(22) Filed: Mar. 17, 2010

(30) Foreign Application Priority Data
Mar. 27, 2009 (TW) 098110078

(51) Int. Cl. G09G 3/20; G09G 3/36

(52) U.S. Cl. 345/87; 345/55

(57) ABSTRACT

Systems for displaying images are provided. The system includes a display device. The display device includes an array substrate, and a transparent electrode stack overlaying the array substrate. The transparent electrode stack includes a first electrode having a first slit, a second electrode having an outer edge disposed corresponding to the interior of the first slit, and a dielectric layer disposed between the first and second electrodes. The dielectric layer electrically isolates the first and second electrodes.

### CROSS REFERENCE TO RELATED APPLICATIONS

This Application claims priority of Taiwan Patent Application No. 098110078, filed on Mar. 27, 2009, the entirety of which is incorporated by reference herein.

### BACKGROUND OF THE INVENTION

1. Field of the Invention

The invention relates to flat panel display technologies, and more specifically to display devices utilizing transverse electric field technologies.

2. Description of the Related Art

In general, a display device utilizing transverse electric field technology driving liquid crystal molecules in a plane approximately parallel to the substrate surface is suggested for improving a narrow viewing angle problem of a widely used TN (twisted nematic) display device.

Transverse electric field technology can be categorized into the following technologies: IPS (In Plane Switching) technology and FFS (Fringe Field Switch) technology. IPS technology arranges comb-shaped pixel electrodes and comb-shaped common electrodes in a display. FFS technology forms an insulating layer, which is sandwiched between a top electrode layer and a bottom electrode layer on a same substrate in a display. For FFS technology, one of the electrode layers is utilized as a common electrode layer, and the other is utilized as a pixel electrode layer. Slits, for example, are formed in the top electrode layer and utilized as openings where an electrode field passes therethrough.

However, display devices utilizing transverse electric field technology have variable and poor optical transmittance.

Thus, a system for displaying images is required to solve the described problems.

### BRIEF SUMMARY OF THE INVENTION

An embodiment of the invention provides a system for displaying images. The system includes a display device. The display device includes an array substrate, and a transparent electrode stack overlaying the array substrate. The transparent electrode stack includes a first electrode having a first slit, a second electrode having an outer edge disposed corresponding to the interior of the first slit, and a dielectric layer disposed between the first and second electrodes. The dielectric layer electrically isolates the first and second electrodes.

Further scope of the applicability of the invention will become apparent from the detailed descriptions given hereinafter. It should be understood however, that the detailed descriptions and specific examples, while indicating preferred embodiments of the invention, are given by way of illustration only, as various changes and modifications within the spirit and scope of the invention will become apparent to those skilled in the Art from the detailed descriptions.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIGS. 1A and 1B show an exemplary cross-section and a top view of a pixel area of a display device of a first embodiment of the invention;

FIGS. 2A and 2B show an exemplary cross-section and a top view of a pixel area of a display device of a second embodiment of the invention;

FIGS. 3A and 3B show an exemplary cross-section and a top view of a pixel area of a display device of a third embodiment of the invention;

FIGS. 4A through 4C show graphs of transmittances in the pixel areas of display devices of the first through third embodiments of the invention;

FIG. 5 shows an exemplary top view of a pixel area of a display device of a fourth embodiment of the invention;

FIG. 6 shows an exemplary top view of a transparent electrode stack of a display device of a fifth embodiment of the invention; and

FIG. 7 schematically shows a system for displaying images of a preferred embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Note that the concepts and specific practice modes of the invention is described in detail by the embodiments and the attached drawings. In the drawings or description, similar elements are indicated by similar reference numerals and/or letters. Further, the element shape or thickness in the drawings can be expanded for simplification or convenience of indication. Moreover, elements which are not shown or described can be in every form known by those skilled in the art.

It is understood that the following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples.

In the subsequent description, phrases such as “substantially parallel (to each other)”, “substantially the same” and etc. . . . mean expected to be parallel (to each other), the same and etc. in design, as in practice, it is difficult to be mathematically or geometrically parallel (to each other), the same and etc. Additionally, when deviation is in an acceptable range of a corresponding standard or specification, it is also recognized to be parallel (to each other), the same and etc. Those skilled in the art are expected to acknowledge, that different standards or specifications, depend upon various properties and conditions, and thus, cannot be specifically listed.

Specific embodiments of the invention for fabrication of a pixel area and a transparent electrode stack of a display device of a system for displaying images are described. It is noted that the concepts of the invention can be applied to any known or newly developed display device and system for displaying images.

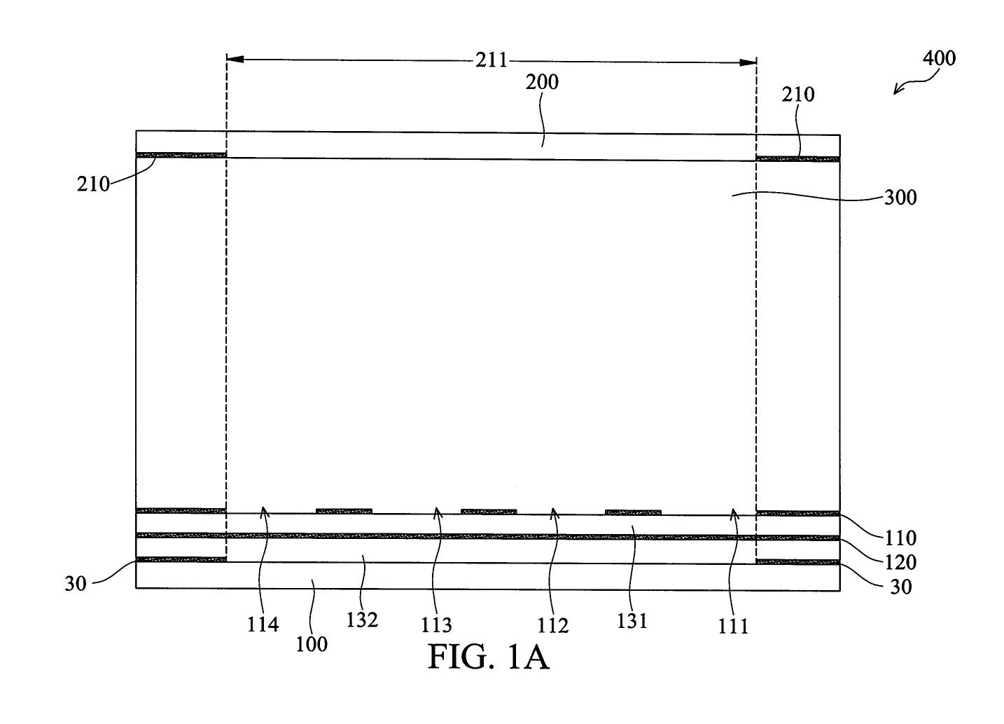

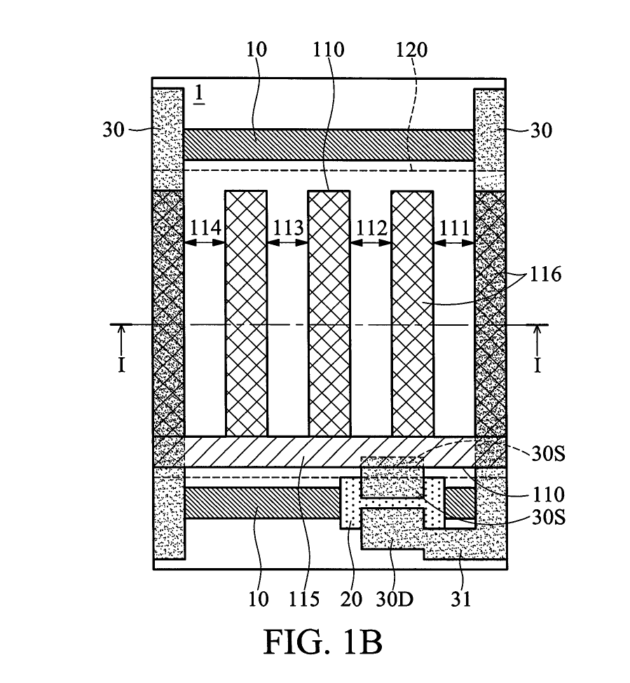

Referring to FIGS. 1A and 1B, a pixel area 1 of a display device 400 of a first embodiment of the invention is shown. FIG. 1A is a cross-section plotted along the cross-section line I-I in FIG. 1B. The display device 400 comprises an array substrate 100. A layer of scan lines 10 and a layer of data lines 30 are disposed overlying the array substrate 100. A dielectric layer (not shown) is disposed between the layer of the scan line 10 and the layer of the data lines 30. The pixel areas (including the pixel area 1) of the display device 400 are defined by the vertical intersection of the scan lines 10 and the data lines 30. A part of a scan line 30 serves as a gate electrode of a thin film transistor. A semiconductor layer 20 is disposed overlying the gate electrode, and a source electrode 30S and a drain electrode 30D are disposed overlying the semiconductor layer 20. Thus forming a thin film transistor. Further, the drain electrode 30D is electrically connected to the corresponding data line 30 by a branch line 31.

A transparent electrode stack is disposed overlying the array substrate 100, and a dielectric layer 132 is disposed between the transparent electrode stack and the layer of the data lines 30. The transparent electrode stack comprises a transparent first electrode 110, a transparent second electrode 120, and a dielectric layer 131 disposed between and isolating the electrodes 110 and 120. Further, the first electrode 110 electrically connects to the source electrode 30S and acts as a pixel electrode. The first electrode 110 comprises a plurality of slits. In this embodiment, the first electrode 110 comprises one connection electrode 115 and five sub-electrodes 116. The five sub-electrodes 116 are connected to each other by the connection electrode 115 and spaced from each other by four open slits 111, 112, 113, and 114. In other embodiments, the quantity and type (open or enclosure) of the slits, and the quantity and type of the sub-electrodes and the connection electrode of the first electrode 110 may depend on requirements. The second electrode 120 is disposed below the first electrode 110, and coupled to a common voltage source of the display device 400, serving as a common electrode. The second electrode 120 has neither openings nor slits, which means the second electrode 120 is formed as an integral whole. Further, the first electrode 110 and the second electrode 120 respectively partially overlap with the data lines 30.

The display device 400, such as a display panel, further comprises an opposite substrate 200, a liquid crystal layer 300, and a light shielding layer 210. The opposite substrate 200 and the array substrate 100 are oppositely disposed and spaced from each other. The liquid crystal layer 300 is filled and disposed between the array substrate 100 and the opposite substrate 200. The light shielding layer 210 is disposed overlying the opposite substrate 200, which is between the substrates 100 and 200. The light shielding layer 210 approximately overlaps the data lines 30 (the extension of the light shielding layer 210 approximately follows that of the data lines 30), and comprises at least one opening 211 exposing the pixel area 1 and parts of the transparent electrode stack not overlapping the data lines 30. Further, at least one slit of the first electrode 110 is disposed corresponding to the opening 211.

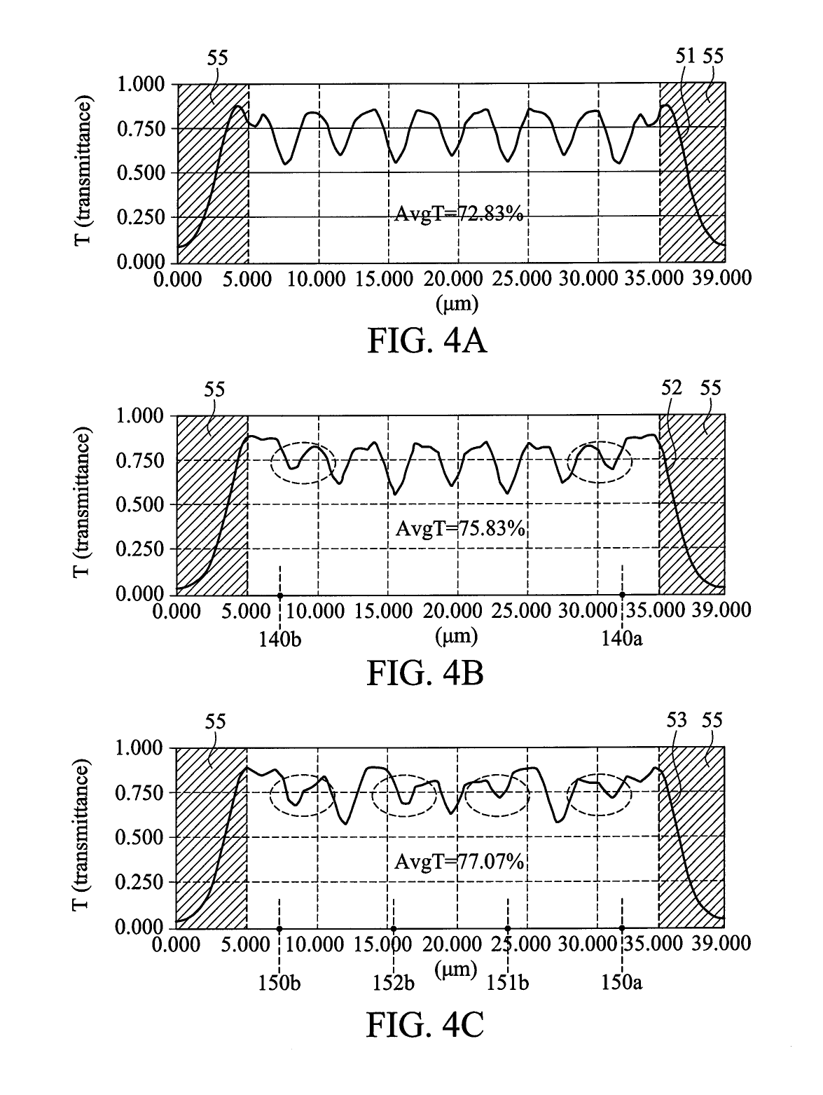

The transmittance in the pixel area 1 of the display device 400 shown in FIG. 1A is shown in FIG. 4A. The area 55 in FIG. 4A corresponds to the area in FIG. 1A affected by the light shielding effects of the light shielding layer 210. The x-axis scales of FIG. 4A correspond to the left-to-right width position of the pixel area 1. The y-axis scales of FIG. 4A indicate the transmittance values. The curve 51 in FIG. 4A indicates the transmittances of every position of the pixel area 1 shown in FIG. 1A. FIG. 4A shows the average transmittance (Avg T) of the pixel area 1 is 72.83%.

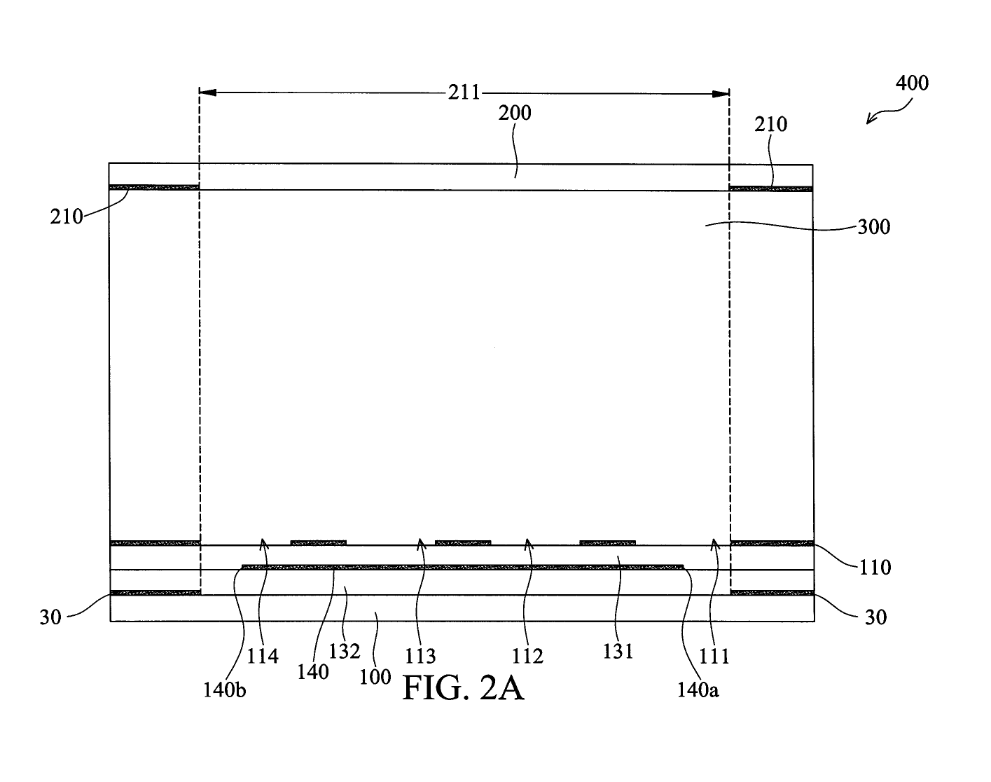

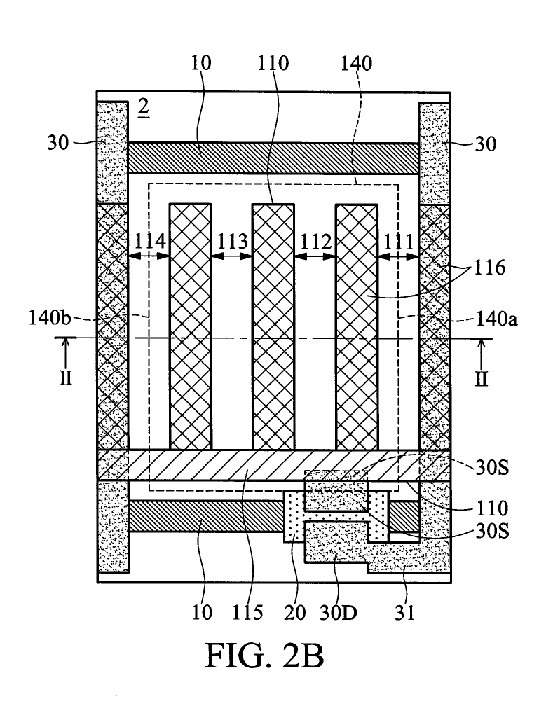

Referring to FIGS. 2A and 2B, a pixel area 2 of a display device 400 of a second embodiment of the invention is shown. FIG. 2A is a cross-section plotted along the cross-section line II-II in FIG. 2B. In some cases, a second electrode 140 in the pixel 2 can replace the second electrode 120 in the pixel 1 shown in FIGS. 1A and 1B.

Only the outer edge of the second electrode 140 of the pixel area 2 of the second embodiment is different from the pixel area 1 of the first embodiment. In FIGS. 2A and 2B, an outer edge 140a of a second electrode 140 is disposed corresponding to the interior of the slit 111 of the first electrode 110, and disposed beyond the two edges of the slit 111 (which means the outer edge 140a fails to overlap the two edges of the slit 111). The two edges of the slit 111 are substantially parallel to the extension direction of the data lines 30. The outer edge 140a may be disposed along the middle of the slit 111 (that is, the outer edge 140a is disposed corresponding to a center line of the slit 111). Further, an outer edge 140b of the second electrode 140 may also be disposed corresponding to the interior of the slit 114 of the first electrode 110. The outer edge 140b may be disposed along the middle of the slit 114. That is, the outer edges 140a and 140b of the second electrode 140 of the second embodiment are respectively disposed corresponding to the interior of the slits 111 and 114 of the first electrode 110. In other embodiments, one of the outer edges 140a and 140b of the second electrode 140 may extend over the neighboring data line 30 as the corresponding edge of the second electrode 120 as shown in FIG. 1B. In this embodiment, further, the outer edges 140a and 140b of the second electrode 140 are both substantially parallel to the extension direction of the data lines 30.

The transmittance in the pixel area 2 of the display device 400 shown in FIG. 2A is shown in FIG. 4B where a curve 52 indicates the transmittances of every position of the pixel area 2. Compared to the curve 51 shown in FIG. 4A, values of troughs, whose orthographic projections on an x-axis are near the positions corresponding to those of the outer edges 140a and 140b of the second electrode 140 in FIG. 2A, of the curve 52 (such as those indicated by dotted circles in FIG. 4B), increase relative to the values of troughs at the corresponding positions of the curve 51. Thus, the transmittance variance in the pixel area 2 decreases, and the average transmittance of the pixel area 2 increases. For example, FIG. 4B shows the average transmittance of the pixel area 2 at 75.83%, greater than 72.83% of the pixel area 1.

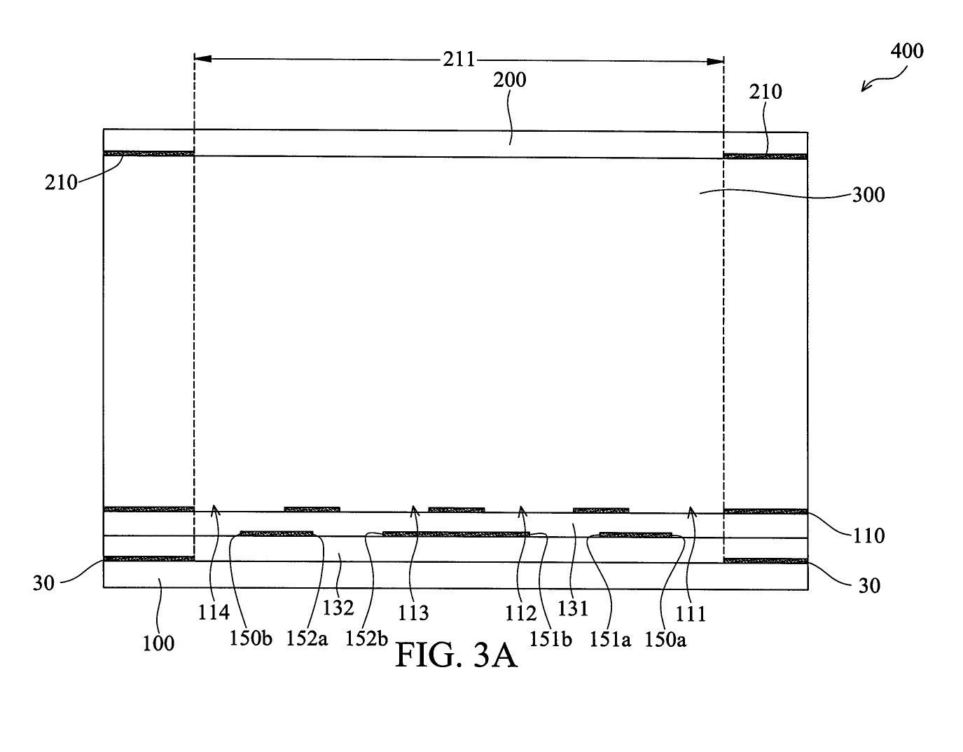

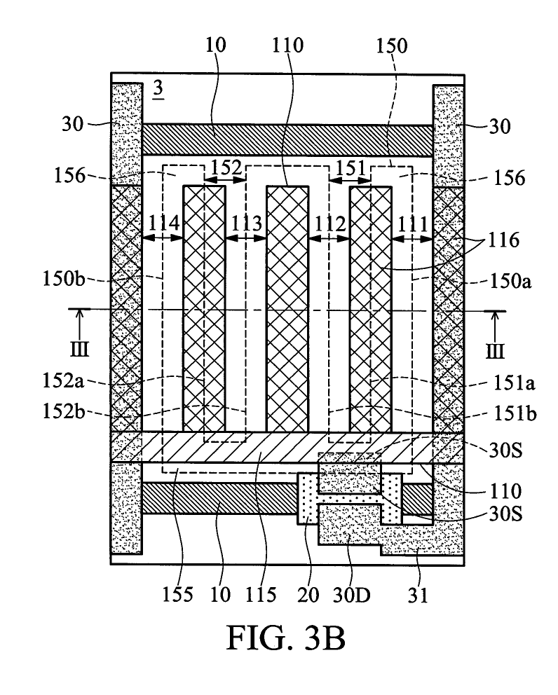

Referring to FIGS. 3A and 3B, a pixel area 3 of a display device 400 of a third embodiment of the invention is shown. FIG. 3A is a cross-section plotted along the cross-section line III-III in FIG. 3B. In some cases, a second electrode 150 in the pixel 3 can replace the second electrode 120 in the pixel 1 shown in FIGS. 1A and 1B or the second electrode 140 in the pixel 2 shown in FIGS. 2A and 2B. The pixel area 3 of the third embodiment is different from the pixel area 2 of the second embodiment in that the second electrode 150 in the pixel area 3 comprises a plurality of slits. In this embodiment, the second electrode 150 comprises one connection electrode 155 and three sub-electrodes 156. The three sub-pixels 156 are connected to each other by the connection electrode 155, and spaced from each other by the two open slits 151 and 152. In other embodiments, the quantity and type (open or enclosure) of the slits, and the quantity and type of the sub-electrodes and the connection electrode of the second electrode 150 may depend on requirements. Further, compared to the second electrode 140 shown in FIGS. 2A and 2B, the increased “edges” due to formation of slits between the sub-electrodes 156 of the second electrode 150 are considered the outer edges of the second electrode 150.

As shown in FIG. 3B, the slits 151 and 152 of the second electrode 150 are respectively disposed corresponding to the slits 112 and 113 of the first electrode 110. The outer edges 151b and 152b of the second electrode 150 respectively along the length directions of the slits 151 and 152 are respectively disposed corresponding to the interior of the slits 112 and 113. The outer edges 151b and 152b may be respectively disposed along the center lines of the slits 112 and 113. In this embodiment, the widths of the slits 151 and 152 are substantially the same as those of the slits 111 through 114. In other embodiments, the widths of the slits 151 and 152 can be greater than those of the slits 111 through 114. In some cases, for example, the slits 151 and 152 can be between 1 and 2 times as wide as the slits 111 through 114. In some cases, the slits 151 and 152 can be numerically wider than the slits 111 through 114. In one embodiment, for example, the slits 111 through 114 are as wide as 3 μm, while the slits 151 and 152 are wider than 3 μm.

In this embodiment, further, only one outer edge 150a of all of the edges of the second electrode 150 orthographically projects on the interior of the slit 111 of the first electrode 110, for example. Moreover, only one outer edge 151b of one slit 151 orthographically projects on the interior of the slit 112 of the first electrode 110, for example.

The transmittance in the pixel area 3 of the display device 400 shown in FIG. 3A is shown in FIG. 4C where a curve 53 indicates the transmittances of every position of the pixel area 3. Compared to the curves 51 and 52 shown in FIGS. 4A and 4B, values of troughs, whose orthographic projections on an x-axis are near the positions corresponding to those of the outer edges 150a, 151b, 152b, and 150b of the second electrode 150 in FIG. 3A, of the curve 53 (such as those indicated by dotted circles in FIG. 4C) are apparently increased relative to the values of troughs at the corresponding positions of the curves 51 and 52. Thus, the transmittance variance in the pixel area 3 decreases, and the average transmittance of the pixel area 3 increases. For example, FIG. 4C shows the average transmittance of the pixel area 3 at 77.07%, greater than those of the pixel areas 1 and 2.

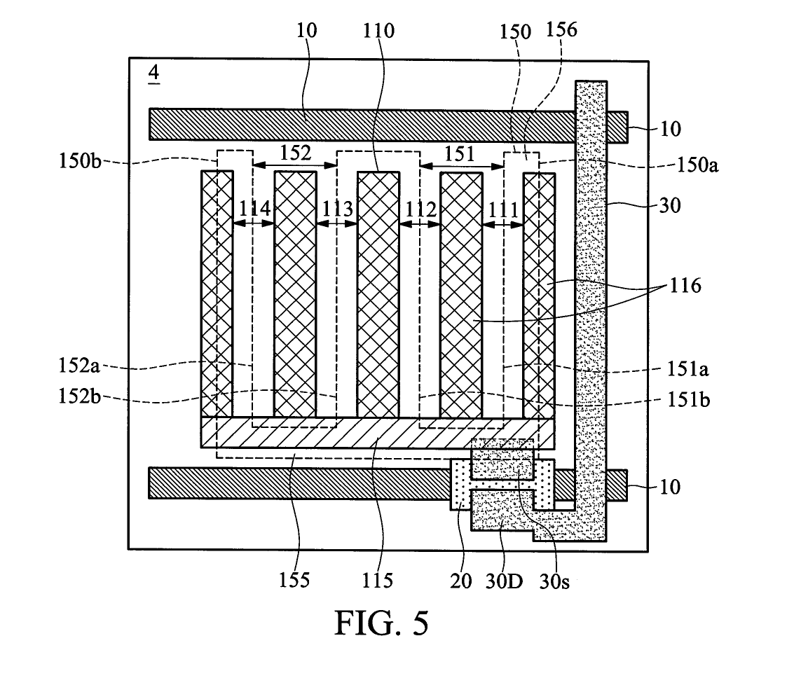

In the device of the fourth embodiment shown in FIG. 5, compared to the device of the third embodiment, the size of the first electrode 110 is reduced, and no longer overlaps the data lines 30. A pair of outer edges 151a and 151b, along the length direction of the slit 151, of the second electrode 150 are respectively disposed corresponding to the interior of the two slits 111 and 112 of the first electrode 110. A pair of outer edges 152a and 152b, along the length direction of the slit 152, of the second electrode 150 are respectively disposed corresponding to the interior of the two slits 114 and 113 of the first electrode 110. The respective corresponding mode between the outer edges of the second electrode 150 and the slits of the first electrode 110 is the same as or equivalent to that between the outer edge 140a of the second electrode 140 and the slits of the first electrode 110 described for and shown in FIG. 2A. In this embodiment, further, the outer edge 150a (or 150b) is disposed corresponding to one sub-electrode 116 of the first electrode 110. In other words, the outer edge 150a (or 150b) orthographically projects on one sub-electrode 116.

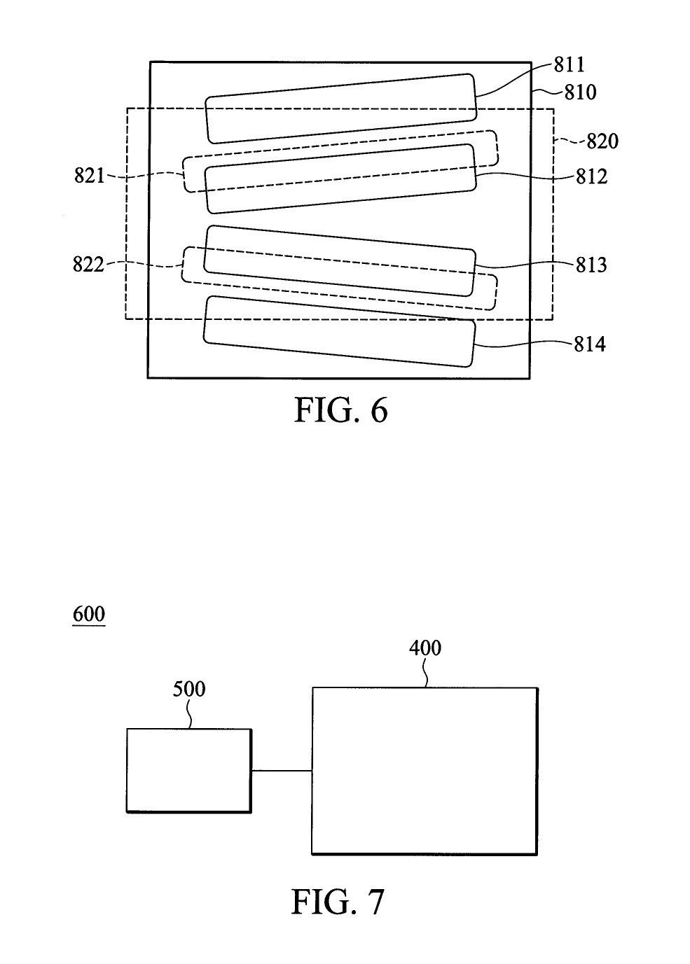

In the fifth embodiment of the invention, the first electrode 110 shown in FIG. 3B or 5 is replaced by a transparent electrode 810 comprising enclosure slits 811, 812, 813, and 814 shown in FIG. 6, and the second electrode 150 shown in FIG. 3B or 5 is replaced by a transparent electrode 820 comprising enclosure slits 821 and 822 shown in FIG. 6. The corresponding mode of relative positions between the transparent electrodes 810 and 820 is the same as or equivalent to that of relative positions between the electrodes 110 and 150 shown in FIG. 3B or 5. The slits 811 and 812 are substantially parallel to each other, and the slits 813 and 814 are substantially parallel to each other, but the slits 812 and 813 are not parallel. A pixel area comprising the transparent electrodes 810 and 820 is called “dual domain”. A pixel area comprising the transparent electrode 820 and modified transparent electrode 810 comprising substantially parallel slits 811, 812, 813, and 814 is called “mono domain”. Further, the profile of the transparent electrode 820 may be modified to have two tapered outer edges respectively disposed corresponding to the interior of the slits 811 and 814, and substantially parallel to directions of the slits 811 and 814.

As shown in FIG. 7, the display device 400 can be assembled with an input unit 500 to fabricate different kinds of the electronic device 600. The display device may comprise only one type of the described pixel areas 1, 2, 3, and 4, or any combination of the described pixel areas 1, 2, 3, and 4. The input unit 500 is coupled to the display device 400, inputting signals, such as image signals, into the display device 400 for image generation and display. The electronic device 600 can be a cell phone, a digital camera, a personal digital assistant (PDA), a notebook computer, a desktop computer, a television, a car display, or a portable digital video disc (DVD) player.

While the invention has been described by way of example and in terms of preferred embodiment, it is to be understood that the invention is not limited thereto. To the contrary, it is intended to cover various modifications and similar arrangements (as would be apparent to those skilled in the Art). Therefore, the scope of the appended claims should be accorded the broadest interpretation so as to encompass all such modifications and similar arrangements.

What is claimed is:

1. A system for displaying images comprising a display device, comprising:
an array substrate; and
a transparent electrode stack overlying the array substrate, and comprising a first electrode comprising a first slit, a second electrode comprising an outer edge disposed corresponding to the interior of the first slit, and a dielectric layer disposed between and electrically isolating the first electrode and the second electrode.

2. The system as claimed in claim 1, wherein the outer edge is disposed corresponding to a center line of the first slit.

3. The system as claimed in claim 1, wherein
the first electrode comprises a plurality of first sub-electrodes; and
the first sub-electrodes are connected to each other by a first connection electrode, and spaced from each other by the first slit.

4. The system as claimed in claim 1, wherein the second electrode is formed as an integral whole.

5. The system as claimed in claim 1, wherein:
the second electrode comprises a plurality of second sub-electrodes;
the second sub-electrodes are connected to each other by a second connection electrode, and spaced from each other by a plurality of second slits; and
the outer edge is an edge of at least one of the second sub-electrodes.

6. The system as claimed in claim 5, wherein the first slit is disposed corresponding to at least one of the second slits.

7. The system as claimed in claim 5, wherein the first slit and the second slits are all open slits.

8. The system as claimed in claim 5, wherein the first slit and the second slits are all enclosure slits.

9. The system as claimed in claim 1, wherein the arrangement of the second electrode is disposed below the first electrode.

10. The system as claimed in claim 1, further comprising a light shielding layer disposed between the array substrate and an opposite substrate, wherein the light shielding layer comprises an opening exposing parts of the transparent electrode stack.

11. The system as claimed in claim 6, further comprising:
an opposite substrate disposed over the array substrate, and facing the transparent electrode stack; and
a liquid crystal layer disposed between the array substrate and the opposite substrate.

12. The system as claimed in claim 1, further comprising an electronic device, comprising:
the display device; and
an input unit coupled to the display device and providing an input signal for the display device, enabling the display device to display images.

13. The system as claimed in claim 12, wherein the electronic device is selected from a group consisting of a cell phone, a digital camera, a personal digital assistant (PDA), a notebook computer, a desktop computer, a television, a car display, and a portable digital video disc (DVD) player.
